(19) United States
(12) Patent Application Publication
(10) Pub. No.: US 2007/0089573 A1
(43) Pub. Date: Apr. 26, 2007

(54) Spin trimmer and method of trimming

(75) Inventors: Ralph Lee Williams, Des Peres, MO (US); Daniel J. Lockwood, O'Fallon, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Lectro Engineering Company

(21) Appl. No.: 11/507,210

(22) Filed: Aug. 21, 2006

Related U.S. Application Data
(60) Provisional application No. 60/729,514, filed on Oct. 24, 2005.

(51) Int. Cl. B23B 1/00

(52) U.S. Cl. 82/47; 83/13

(57) ABSTRACT

Apparatus is disclosed for trimming scrap material, such as a dome or moil, from a plastic container or other object, which is typically formed with the neck of the container during molding. The apparatus comprises a pair of power driven endless belts, each having an inner reach with the inner reaches of the belts being spaced apart from one another so as to grip a portion of the container (typically the scrap dome or moil to be trimmed) therebetween and so as to move the container along a path. The belts are driven so that the inner reaches of each of the belts move in the same direction so that a container gripped between the belt reaches is conveyed along the work path. One of the belts is driven at a surface speed faster than the surface speed of the other belt so as to rotate the container gripped by the belt reaches about a vertical axis. An elongate blade extends along at least a portion of the work path and is positioned proximate to the work path so as to trim the scrap from the container as the container is conveyed along the work path and as the container is rotated by the belt reaches. A method of trimming such scrap is also disclosed.

### CROSS-REFERENCE TO RELATED APPLICATIONS

This application claims the benefit of my co-pending U. S. Provisional Patent Application No. 60/729,514, filed Oct. 24, 2005, which is hereby incorporated by reference.

### STATEMENT REGARDING FEDERALLY SPONSORED RESEARCH OR DEVELOPMENT

Not Applicable.

### BACKGROUND OF THE INVENTION

This invention relates to a spin trimmer for trimming scrap (e.g., a so-called “dome” or “moil”) from the upper portion (e.g., the mouth or neck) of a formed plastic object, such as a blow molded, injection molded, or rotationally molded plastic container or other object, such as a ventilation duct, from which scrap must be trimmed. Typically, the objects trimmed by such spin trimmers are blow molded containers, such as bottles, jugs, jars, or the like. However, within the broader meaning of the instant disclosure, those of ordinary skill in the art will recognize that the spin trimmer herein disclosed may be used to trim a wide variety of plastic objects, regardless of the process used to form such objects. When the term “container” is used in this disclosure or in the claims, it will be understood that such term will not be limited to bottles, jugs, or jars, but will be understood to cover any object regardless of the manner in which it was formed or molded and regardless of whether it is, in fact, a “container”.

Typically, when such an object, such as a container, is blow molded, the blow mold machine forms (e.g., extrudes) a parison of semi-molten plastic resin in a heated and pliable state. The parison is internally pressurized with air within a female mold of the desired shape for the container and the parison will take the shape of its mold. In blow molding a bottle or jug with a mouth, the scrap (the dome or moil) is integrally attached (i.e., is one piece with the body of the container) to the upper edge of the mouth and it must be trimmed from the container. However, other types of containers may be molded using other processes, such as “stretch/form” blow molding or injection molding techniques. In a stretch/blow molded container, a preformed (e.g., injection molded) parison is molded of a suitable resin, such as PET. The parison is heated to a softening temperature and is placed within a female mold. A rod is inserted through the mouth of the parison so as to stretch the parison to the length of the mold and then, immediately after such stretching, the parison is internally pressurized so that it takes the shape of the mold. Oftentimes, scrap must be trimmed from the upper reaches of the parison so as to form the desired object or container.

Various machines over the years have been introduced to trim such scrap (referred to as moil or a dome) from such molded objects or containers. These trimming machines may take on a variety of forms, one of which is referred to as a “spin trimmer”. A characteristic of prior art spin trimmers is that they a have one or two belts that engage the neck (or other portion) of the container and rotate the neck of the container or object (and thus rotate the container) as the belt(s) move the container along a path past a stationary knife which cuts the dome from the neck of the bottle. One such spin trimmer is described in U.S. Pat. No. 5,257,560, which employs two belts having inner reaches spaced apart so as to grip a portion of a container (e.g., the moil or the neck of the container) therebetween. The belts of this prior art trimmer are driven in such manner that the inner reaches of the belts in engagement with the neck of the container move in opposite directions so as to spin the bottle about a vertical axis as the container is conveyed past a stationary heated or unheated knife blade. While these prior art spin trimmers worked well for trimming smaller containers, it has been found that for larger containers (e.g., one gallon bottles or jugs), and particularly for such larger containers where the neck of the container is offset from the vertical centerline axis (i.e., the axis of symmetry) of the container, when the containers were spun at a relatively high speed by the belt reaches moving in opposite directions, such off-center containers would wobble. This wobbling sometimes caused the container to become disengaged from between the belts, or caused uneven cutting by the stationary knife blade. When the container became disengaged from the belts, it would jam the trimmer. Thus, it was often necessary to stop the trimmer to remove the container that had become disengaged from the belts and caused the trimmer to jam. Because the trimmer was in line with the blow molding machine, when the trimmer was shut down to clear a jam, it sometimes became necessary to stop the blow molding machine, which would result in a loss of container production. Also, uneven cutting of the wobbling containers resulted in the scrap not being reliably cut from the container, thus resulting in improperly trimmed containers being rejected in subsequent quality control inspections. Still further, because the container trimmed in such prior art spin trimmers were spun at relatively high speeds (as compared to the trimmer disclosed herein), the rapidly spinning trimmed containers, particularly non-symmetrical containers, were unstable as they were released from such prior art trimmers and oftentimes would tip over on the outfeed conveyor causing the trimmer to jam again necessitating the shut down of the trimming machine with attendant production delays while the jam was cleared.

Other spin trimmers were known, such as shown in U.S. Pat. No. 4,876,930. In addition, spin trimmers sold by Lectro Engineering Company of St. Louis, Miss. in the United States more than one year prior to the effective filing date of this disclosure utilized a pair of belts, one above the other, disposed on one side of the container dome to be trimmed with the container held against an elongate guide rail so that upon operation of the belts, both belts were driven in the same direction and the container was caused to rotate on the stationary guide rail and to be conveyed along the stationary guide rail. A stationary, elongate knife was provided that angled inwardly from the guide rail so as to sever the scrap dome or moil from the container and the container was spun and conveyed along the stationary guide rail. It is, however, important to note that, like the trimmer described in the above-identified U.S. Pat. No. 5,257,560, that the container was spun at a relatively high rotational speed that made unsymmetrical containers wobble as they were conveyed through the trimming apparatus.

### BRIEF SUMMARY OF THE DISCLOSURE

Apparatus is herein disclosed for trimming scrap material, such as a dome or moil, from the neck or mouth of a blow molded plastic container. This apparatus comprises a pair of power driven endless belts, where each of the belts has an inner reach with the inner reaches of the belts being spaced apart from one another so as to grip the portion of the container (e.g., the scrap or the neck of the container) therebetween. The belts are driven so that the inner reach of each of the belts moves in the same direction so that a container gripped between the belt reaches is conveyed along a work path). The inner reach of one of the belts is driven at a surface speed somewhat faster than the surface speed of the inner reach of the other belt so as to rotate the container about a vertical axis. An elongate blade extends along at least a portion of the work path and is positioned proximate to the work path so as to trim the scrap from the container as the container is conveyed along the work path and as the container is rotated by the belt reaches.

Also, a method of trimming scrap material from a blow molded plastic container is disclosed where the container has a neck and scrap material is attached to the neck. The method comprises the steps of gripping a portion of a container to be trimmed between a pair of spaced belt reaches. Both of the belt reaches are driven in the same direction so as to convey the container along a work path. One of the belts reaches is driven at a surface speed somewhat faster than the surface speed of the other belt reach so as to rotate the container about a vertical axis as the container is conveyed along the work path. And, an elongate knife blade is positioned along the work path so as to trim the scrap from the neck as the container is conveyed and rotated along the work path.

### BRIEF DESCRIPTION OF THE SEVERAL VIEWS OF THE DRAWINGS

FIG. 1 is a perspective view of a portion of the trimming apparatus embodying aspects of the present invention with portions of the frame removed for clarity illustrating an infeed conveyor for delivering blow molded containers to the trimming apparatus, the latter having a pair of parallel endless belts with the inner reaches of the belts gripping a portion of the container (e.g., gripping the scrap material attached to the neck of the container) for conveying the container through the trimmer and for slowly rotating the container about the axis of its neck as the container is conveyed past a heated, stationary knife that trims the scrap from the container neck;

FIG. 2 is a top plan view of the trimming apparatus illustrated in FIG. 1;

FIG. 3 is a right end elevational view of the trimming apparatus;

FIG. 4 is a side elevational view of the trimming apparatus;

FIG. 5 is an enlarged end right-hand end elevational view of the apparatus illustrating an unsymmetrical container having an offset neck where the scrap attached to the neck is gripped by the inner reaches of the belts with a knife blade positioned to cut the scrap from the neck of the container as the latter is conveyed through the apparatus;

FIG. 6 is an enlarged end elevational view of a portion of the container illustrating a container having an offset neck where the scrap is gripped between the inner reaches of the movable belts and illustrating a stationary knife blade trimming the scrap from the neck of the container;

FIG. 6A is a plan view on an enlarged scale of a cutting blade having an elongate cutting edge and a sharp corner for initially penetrating through the wall of the container moil or neck so as to predictably pierce the wall at a predetermined location along the length of the blade; and

FIG. 7 is a diagram of a computer control system for controlling operation of the trimming apparatus.

Corresponding reference numbers illustrate corresponding parts throughout the several views of the drawings.

### DETAILED DESCRIPTION OF PREFERRED EMBODIMENTS

The following detailed description illustrates the invention by way of example and not by way of limitation. This description will clearly enable one of ordinary skill in the art to make and use the invention, and describes several embodiments, adaptations, variations, alternatives and uses of the invention, including what I presently believe is the best mode of carrying out the invention. Additionally, it is to be understood that the invention is not limited in its application to the details of construction and the arrangements of components set forth in the following description or illustrated in the drawings. It is to be further understood that the claims describe the subject matter that I regard as my invention and that the claims need not embody all of the objects, features, embodiments, or variations of the embodiments described herein.

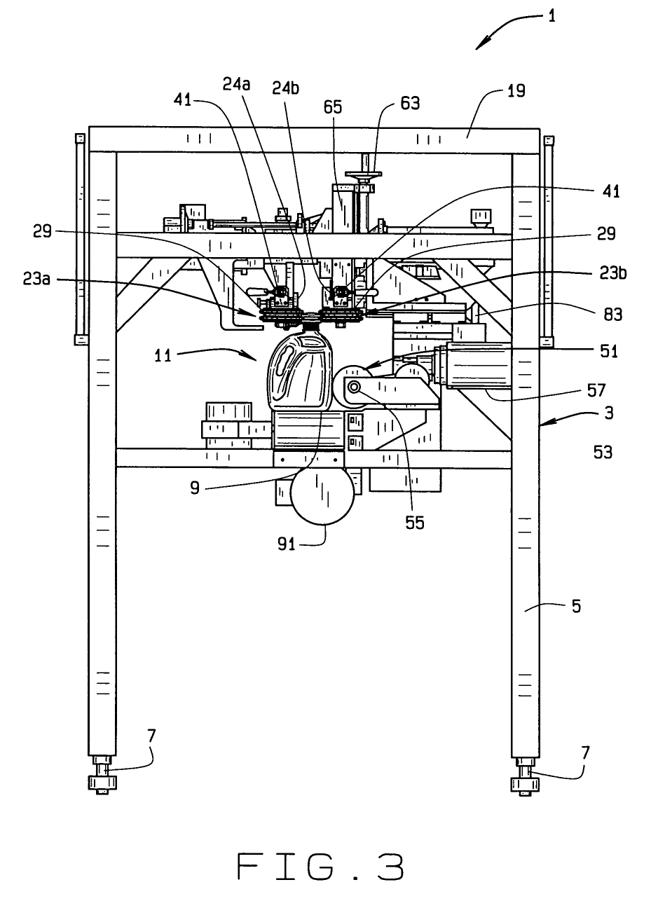

Referring now to the drawings, a preferred embodiment of a trimming apparatus embodying the present invention is indicated in its entirety by reference character 1. The apparatus has a frame 3 including legs 5 (see FIG. 3). Casters 7 (see FIG. 3) are preferably (but not necessarily) provided on the bottom of the legs so as to facilitate moving the apparatus. As indicated at 9, a container delivery shelf is provided for supplying containers 11 to the trimming apparatus. As shown, shelf 9 may be a stationary shelf or surface for supporting the bottom of the containers to be trimmed. However, those skilled in the art will appreciate that the shelf may be replaced by a conveyor belt or the like which not only supports the containers, but aids in conveying the containers toward the trimming apparatus 1.

In use, trimming apparatus 1 is preferably positioned downstream from the output of a blow mold machine (not shown) which blow molds objects or containers 11 from any suitable plastic resin. Blow mold machines are well known to those skilled in the art and as such do not form a part of this invention. The blow molded containers discharged from a blow mold machine typically have scrap (referred to as a “dome” or as a “moil”) that must be trimmed from the container before use. Those skilled in the art will understand that the trimmer 1 may be used to trim scrap from a wide variety of plastic objects other than container, which may be formed by methods other than blow molding. For example, objects formed by stretch blow molding or injection molding may be trimmed by apparatus 1. Further, those skilled in the art will recognize objects to be trimmed may be supplied to the spin trimmer 1 from a wide variety of sources and that the spin trimmer 1 need not be positioned to receive objects from a blow molding or other machine. Thus, when the term “container” is used in this disclosure or in the claims, it will be understood to include all such objects that may be trimmed by the apparatus and method of the present disclosure.

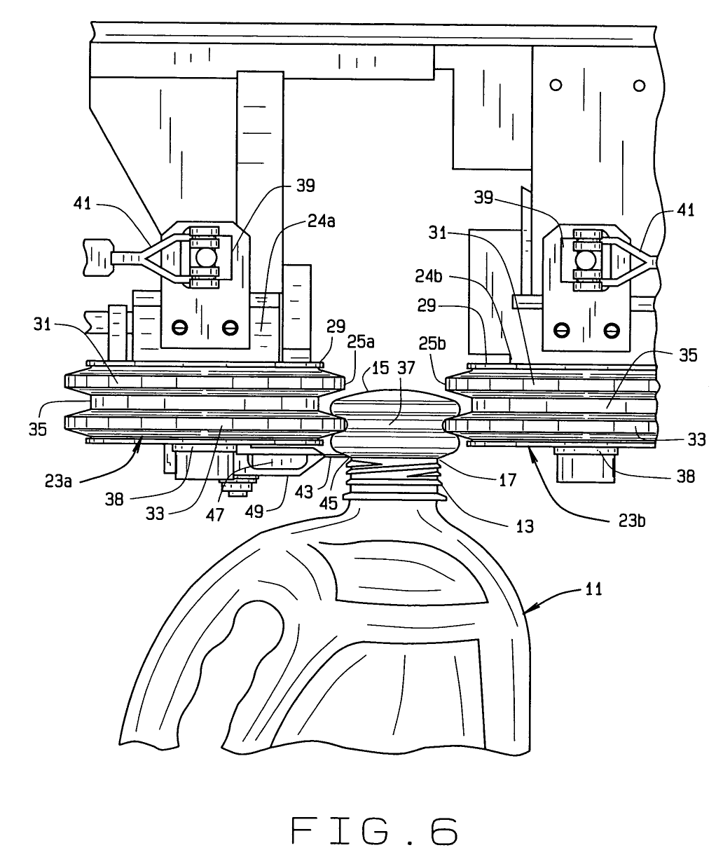

As best illustrated in FIG. 6, container 11 is a bottle or jug having a neck 13 at its upper end. As shown, neck 13 of container 11 is threaded, but it will be appreciated that the neck need not be threaded. At the upper end of the neck, a scrap dome or moil 15 is shown. This scrap dome is typically formed in the blow mold machine forming the container and is integral (i.e., formed in one piece with the container) with the neck (mouth) of the container. That is, the moil and neck of the container may be of one homogenous piece. However, one skilled in the art will recognize that the container may be co-extruded and may be comprised of one or more layers of different resins. The intersection of the upper end of neck 13 and dome 15 forms a trim line or cut groove, as indicated at 17, along which the dome is to be trimmed or cut from the neck. While the scrap is herein illustrated as being located at the top of neck 13, those skilled in the art that the trimmer 1 of this invention may be adapted to trim flash or other scrap from other locations on the container. As shown in the drawings, the neck 13 of container 11 is shown to be cylindrical (i.e., of circular cross section) and to be offset with respect to the vertical centerline of the container so that the container is unsymmetrical with respect to the vertical centerline. However, it will be understood that the apparatus and method of the present invention operates with containers have centered as well as offset necks, and that the necks or moils need not be cylindrical, but could be of any curved shape, such as an oval or other curvilinear shape.

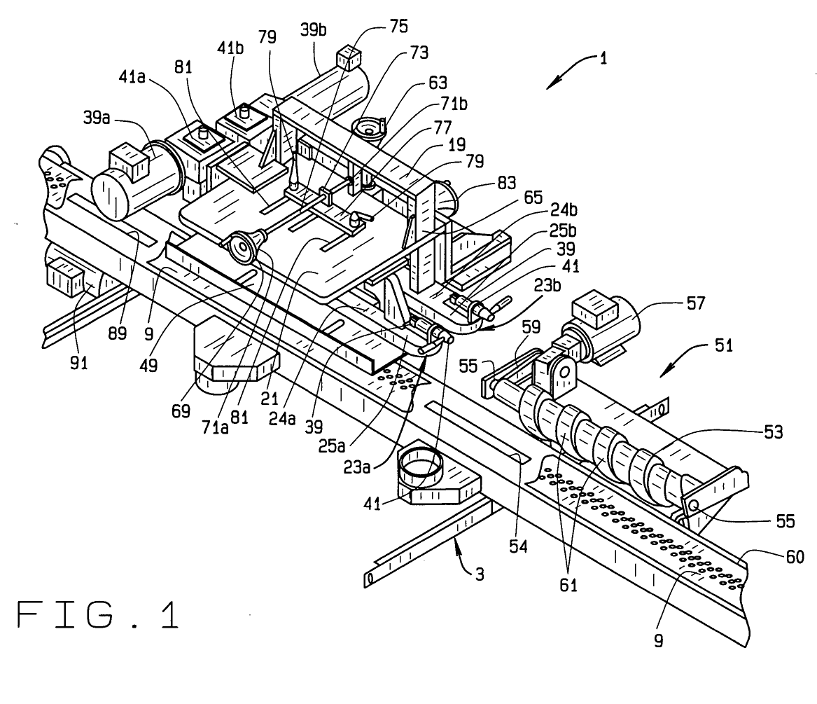

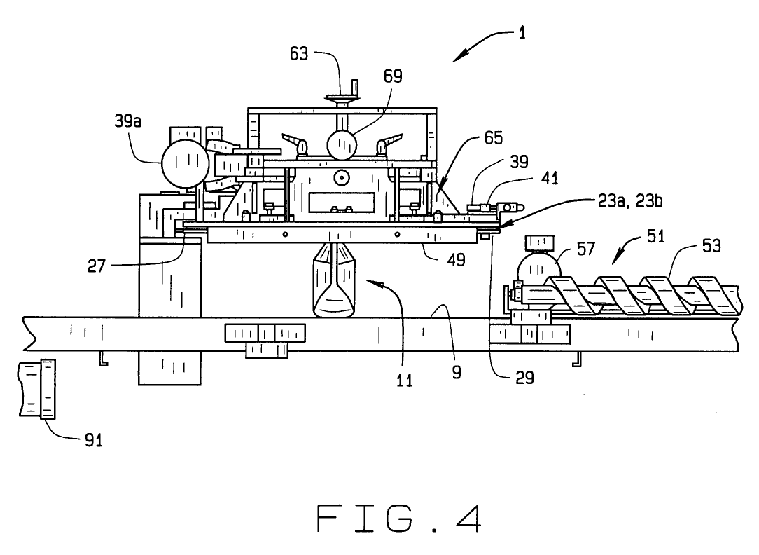

Referring again to FIG. 1, frame 3 includes a trimming frame 19 having a horizontal support plate 21 which carries a pair of power driven endless belts 23a, 23b. Each of the belts 23a, 23b is carried by a respective belt frame 24a, 24b. As described in detail hereinafter, these belt frames are movable toward and away from one another so that the belts may grip the moils 15 of different diameters or cross sections between the inner reaches 25a, 25b of the belts and so as to be centered with respect to the moils (or necks) of containers of different configurations, even if the moils (or necks) are offset from the center of the containers. The inner belt reaches 25a, 25b are, preferably, generally parallel to one another and are spaced from one another. Each of the belts is entrained around a respective driven pulley 27 and an idler pulley 29 (see FIG. 4).

As best shown in FIG. 6, each of the belts 23a, 23a preferably, but not necessarily, has a pair of spaced raised ribs 31, 33, with a groove 35 therebetween. As best shown in FIG. 6, the lower belt surface or rib 33 is preferably (but not necessarily) received in a corresponding belt groove 37 formed in dome 15. With belts such as shown in FIG. 6, it will be appreciated that if the lower belt surface or rib 33 becomes worn, the belt can be removed from pulleys 27 and 29 and turned over and re-installed on the pulleys such that the previously unused belt surface or rib 31 engages the belt groove 37 in the containers to be trimmed thus effectively doubling the service life of the belts. It will be appreciated that the belts 23a, 23b are preferably steel reinforced timing belts having spaced timing belt teeth (not shown) on the backside of the belts. Pulleys 27 and 29 are preferably timing belt pulleys having spaced teeth and grooves where the grooves receive the teeth on the backside of the belts 23a, 23b. Such timing belts are preferred because they insure that the belts are positively driven and substantially eliminate slippage of the belts relative to their pulleys thus insuring that the speed of the belts can be precisely controlled. It will be further understood that the belt ribs 31, 33 may be segmented so that the belts may be more readily entrained around pulleys 27 and 29 of relatively small diameter (compared to the thickness of the belts) so as to minimize cracking of the belts.

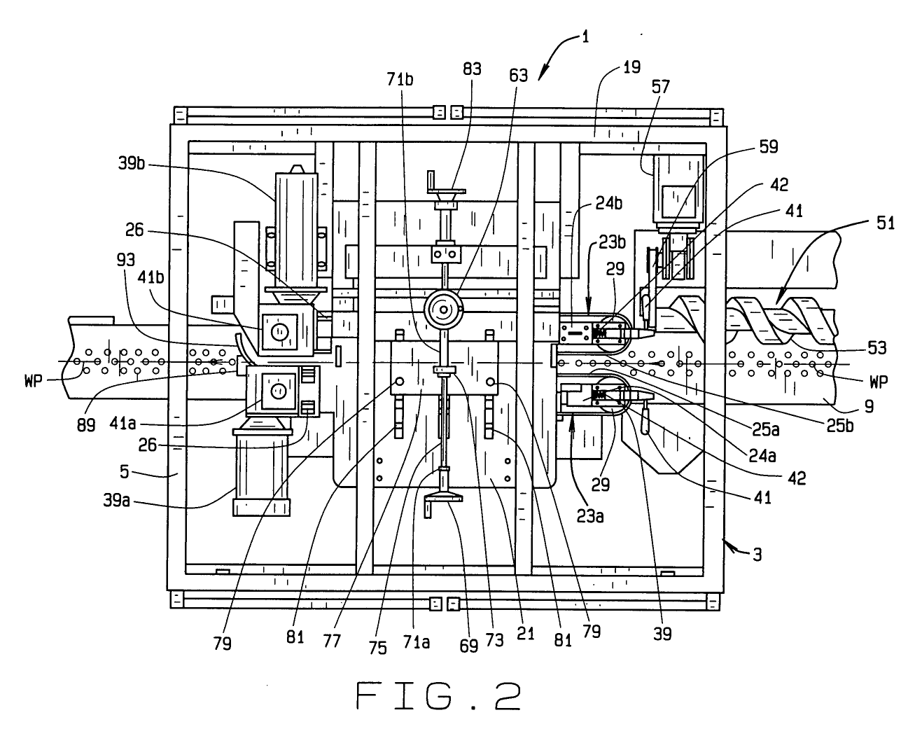

Each of the idler pulleys 29 is mounted on a belt tensioner 39 which is operated by an overcenter clamp 41 for movement in a horizontal direction toward and away from its corresponding drive pulley 27 between a retracted position (not shown) which allows the endless belt to be readily installed on the driven and idler pulleys 27 and 29 and a tensioned position (as shown in all of the drawings, but which is best shown in FIG. 4) in which the belt is tensioned (stretched) around the pulleys. As will be appreciated by those skilled in the art, the belt tensioners 39 may be adjustably mounted with respect to the frame such that the distance between the centers of the idler and drive pulleys may be adjusted when the tensioner is in its tensioned position so as to insure proper tension on the belts and to accommodate differences in belt dimensions and stretching of the belts. Further, those skilled in the art will recognize that each overcenter clamp 41 mounts the idler pulleys 29 so that an adjustable compression spring 42 (as best shown in FIG. 2) may be incorporated in the clamp to maintain its respective belt under a predetermined tension (within a limited range) applied to the belts as the overcenter clamps are actuated thereby to minimize the need to mechanically adjust the distance between the pulleys when the belts are changed. Also, such compression springs will maintain the belts under a relatively constant tension, even if the belts stretch somewhat while in use. The use of such an overcenter mount with such compression spring allows for quick belt changes and insures that upon changing of the belts, the new belt has the proper tension. Of course, the pulleys are mounted on suitable bearings 38 (as shown in FIG. 6) in the manner well known to those skilled in the art.

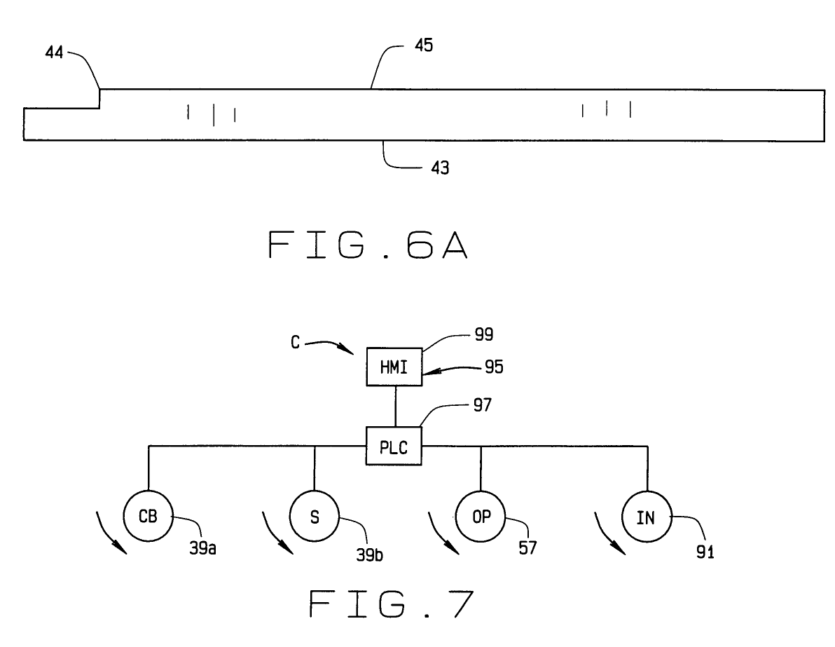

Each of the belts 23a, 23b is power driven by a respective drive motor 39a, 39b. Preferably, these motors are AC inverter variable speed VFD scalable speed vector drive motors (preferably of about ½ horsepower) commercially available from a variety of motor manufacturers. Each of these motors drives a respective speed reducer 41a, 41b which in turn rotates its respective drive pulley 27 so as to cause its endless belt 23a or 23b to be driven around the pulleys. Preferably, the speed of each of the motors 39a, 39b is independently controlled under the control of a computer controller C, as will be hereinafter described and as illustrated in FIG. 7. While the use of such AC inverter VFD motors are preferred, those skilled in the art will appreciate that within the broad aspects of this invention, any suitable motor can be used to drive the belts.

As noted, the speed of motors 39a, 39b may be infinitely varied between 0 RPM and about 2,000 RPM or more. If pulleys 27 have an effective diameter of about 4 inches and if the pulleys are rotated at about 200 RPM, the surface speed of each of the belts may be varied between 0 and about 200 feet/minute or more. Because motors 39a, 39b are preferably (but not necessarily) of infinitely adjustable speed, the surface speed of the belts can also be infinitely varied between 0 feet/minute and whatever surface speed is desired (within the limits of the apparatus 1) to as to accomplish the desired trimming of the scrap from the containers and for insuring that the apparatus 1 has the desired throughput (i.e., the trimming of a desired number of containers or objects in a unit of time). Of course, those skilled in the art will recognize that faster speed motors may be employed and drive pulleys with larger or smaller effective diameters may be used so as to vary the surface speed of the belts. As best shown in FIG. 6, the inner reaches 25a, 25b of the belts 23a, 23b are generally parallel to one another and are spaced apart from one another. It will be understood that the inner reach of each of the belts is backed up by a stationary wear strip 26 (as indicated in FIG. 2), preferably made of a suitable wear resistant material, such as a graphite filled nylon material.

As indicated by the arrows in FIG. 2, belts 23a, 23b are driven by their respective motors 39a, 39b so that the inner reaches 25a, 25b of the belts move in the same direction. The inner reaches of the belts are adjustably spaced apart from one another such that with the neck 13 of a container 11, and preferably, with the scrap dome 15 on the neck, gripped between the inner reaches of the belts, the container 11 is conveyed along a work path WP (as best shown in FIG. 2) through the trimmer as the belts are driven.

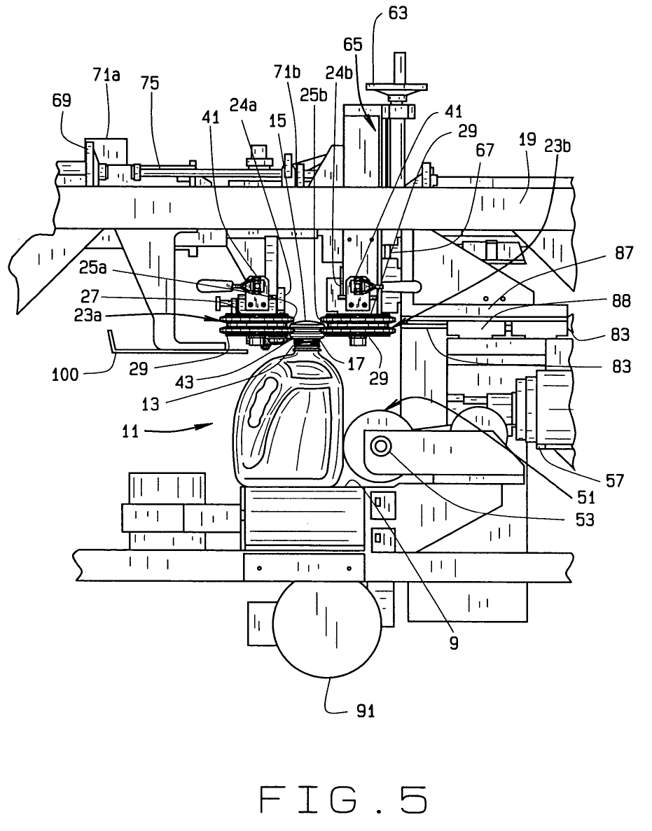

Referring now to FIG. 6, an elongate knife blade 43 extends along a portion of work path WP, with this portion of the work path being sometimes referred to as the trim area of the apparatus. Knife blade 43 is provided with an elongate, sharp cutting edge 45. Preferably (but not necessarily), knife blade 43 is heated by an electric resistance heater 47 to a temperature of about 300° F.-about 450° F. (or more, depending on the material of the container to be trimmed) so that the heated blade will more readily cut the moil 15 from the neck of the container and leave a relatively cleanly trimmed neck surface with little or no scrap, curls or chips remaining attached to the neck or loosely discharged as the cut is made. Specifically, knife blade 43 is affixed to a blade mount 49 which extends below the elevation of belts 23a, 23b. Electric resistance heater 47 is housed in the portion of the blade mount closest to blade 43 so as to heat the blade to a desired operating temperature (e.g., up to about 450° F.) so as to aid the knife in cleanly cutting the scrap dome 15 from the container. The blade mount 49 is thermally insulated from the structure of the trimmer so that heat will not be readily transferred from the heated blade to the structure of the trimmer. It will be appreciated by those skilled in the art that the temperature to which blade 43 is heated will vary depending on the resin from which the blow molded containers 11 being trimmed are formed. A blade guard, as indicated at 100 in FIG. 5, is positioned below blade 43 to as prevent a machine attendant from inadvertently contacting the heated blade in the event the attendant must reach into the apparatus.

The blade mount 49 is preferably in the form of a releasable clamp that allows the blade 43 to be readily changed. The blade preferably tapers inwardly toward the work path WP so that as the container is conveyed through the work path, the blade progressively cuts (preferably but not necessarily both pressure cuts and slices) deeper into the wall of the container so as to cleanly trim the moil or dome from the container. By “pressure cut”, it is meant that the force that the cutting edge of the blade exerts on the trim line 17 is sufficient to result in cutting of the trim line, and by “slice”, it is meant that the moil at least in part slides on the cutting edge 45 of blade 43 as the container is moved along the blade. Still further, the length of the blade is such that it will cuttingly engage the container to be trimmed for at least one full revolution of the container after the blade has initially penetrated through the moil along trim line 17. Because of the inward taper of blade 43, the blade not only applies cutting pressure to trim line 17 so as to pierce the wall of the container along the trim line, the belts 23a, 23b convey the moil relative to the blade at a surface speed faster than rolling speed of the rotating moil so that the blade also effects a slicing action along the trim line. It will be appreciated that the blade 43 may be optionally provided with a sharp corner or penetrator, as indicated at 44 in FIG. 6A, that will reliably penetrate or pierce through the wall of the container along the trim line 17 at a predetermined location along the trim blade and along the work path WP. This results in a more predictable location along the length of the blade where the blade initially cuts through a portion of the moil, regardless of the thickness (within a limited range) of the moil.

The length of blade 43 must be sufficient such that after the wall of the trim line is pierced, as above described, the moil (or neck) will be rotated at least one full revolution to fully trim the moil from the container. Of course, once a moil gripped by the inner reaches 25a, 25b of the belts has been fully trimmed from the container, the container will be released from the belts for outfeed from the trimmer in the manner as will be hereinafter described. For many such, applications, the length of the blade may range between about ten (10) inches and about forty (40) inches. However, those skilled in the art will recognize that the length of the knife will vary with the diameter of the container neck and the material (plastic resin) from which the container 11 is molded.

As described above, the belts 23a, 23b are shown to grip the moil 15 so that the blade 43 fully trims the container from the moil. Those skilled in the art will recognize that the belts may grip the neck 13 of the container so that the blade trims the moil from the neck. Thus, when it is described that the belts grip the container, it will be understood that the belts can be in gripping engagement with the moil, the neck or some other portion of the container so that the container is caused to rotate.

A container infeed conveyor, as generally indicated at 51, may optionally be provided upstream from the entrance to work path WP. One embodiment of such an infeed conveyor 51 is shown to comprise a feeding screw 53 rotated about a horizontal axis extending generally parallel to the direction of work path WP. The ends of screw 53 are journaled in suitable bearings 55 and the screw is rotary driven by a motor/speed reducer 57. The output of the motor/speed reducer drives a belt and pulley arrangement 59 (See FIG. 1) for rotating screw 53. Preferably, motor/speed reducer 57 is a variable speed, AC inverter VFD motor under control of the computer controller C so that the rate the containers to be trimmed are fed to the belts 23a, 23b may be matched to the operating speed of belts 23a, 23b and so that containers gripped by the belts will have a desired spacing. It will be noted that screw 53 has helical flighting 61 with the spacing (pitch) between adjacent flights sufficient to receive one of the containers 11 between adjacent flights thereby to space the containers and to positively feed containers 11 to the work path WP at a desired rate with a desired spacing between adjacent containers gripped by belts 23a, 23b. It will be understood that by varying the rotational speed of screw 53, the rate at which containers are fed to the work path WP for being trimmed may be varied. Further, the pitch of the flights on screw 53 may be varied (e.g., the thickness of the flights progressively increases toward the outlet end of the screw) so that the containers will be ejected from the screw at a linear velocity somewhat faster than the incoming containers are transported by the inlet end of the screw. This variable spacing of the containers by the screw conveyor 53 allows for spacing of containers with offset necks so that as the containers are rotated by the inner belt reaches 25a, 25b, there is sufficient spacing between adjacent containers gripped by the belts so as to permit rotation of such unsymmetrical containers without interference with one another. However, as noted above, the provision of such an infeed conveyor is only preferred. Also, those of ordinary skill in the art will recognize that other infeed conveyors well known in the art may be used in place of screw 53.

As shown in FIG. 1, the container delivery shelf 9 is, preferably, the upper reach of a conveyor belt 60 (shown in phantom) with its upper reach disposed on top of container delivery shelf 9. It will be appreciated that the upper reach of this conveyor belt is driven at a surface speed somewhat greater than the linear velocity of the container released from infeed conveyor screw 53. This conveyor belt conveys the containers from the infeed conveyor so as to be picked up and gripped by belts 23a, 23b. As shown at 54, a vacuum inlet is formed in the delivery shelf 9 under the upper reach of conveyor belt 60. This conveyor belt 60 is of porous construction so that a partial vacuum is drawn through the belt in the region that the containers are released from the infeed conveyor screw 53. In this manner, the vacuum holds or stabilizes the base of the containers on the conveyor belt 60 as the containers are released from the infeed conveyor screw and as the containers are conveyed to be gripped by belts 23a, 23b. It will be appreciated that the vacuum stabilizes the containers on the conveyor belt and minimizes the tendency of the containers to tip over as they are released from the conveyor screw before they are gripped by the belts. Those skilled in the art will understand that any vacuum source of sufficient capacity may be used to apply the partial vacuum to vacuum inlet 54.

Also, if containers 11 are delivered to the screw 53 from a blow mold machine or the like, the containers will accumulate on the container delivery shelf 9 upstream from screw 53 and will thus constitute a buffer so as to insure a steady supply of containers is available to be fed to the trimmer. While infeed conveyor 51 is shown to be in the form of a screw conveyor, those skilled in the art will recognize that other infeed apparatus as widely used in the art may be utilized to feed containers to be trimmed into the trimmer of the present invention. For example, containers to be trimmed resting on a driven conveyor belt 60 or movable support may be accumulated behind a gate that is selectively opened on a timing basis or as the containers are trimmed so that the next container to be trimmed is moved toward the trimmer to be gripped by the belts so as to be rotated and moved linearly along the work path WP. Further, those skilled in the art will recognize that a container infeed system utilizing one or more belts may be employed to feed and to properly space the feeding of containers to be trimmed to the trimming apparatus of the present invention. Such an infeed system may utilize one or more belts driven so as to allow the containers to pass through the belts, but where the speed of the belts would be controlled so as to feed the containers to the trimming apparatus at a desired rate (e.g., X containers/minute) and to control the spacing between adjacent containers fed to the trimming apparatus.

The spacing between the inner reaches 25a, 25b of belts 23a, 23b may be adjusted so that the inner reaches of the belts may be adjusted toward and away from one another so that the space between the inner reaches of the belts may be centered with respect to a container to be trimmed. This allows the trimmer to grip containers of different sizes and to accommodate different neck diameters. Further, the belt reaches 25a, 25b, work path WP, and knife blade 43 may be moved (adjusted) relative to the containers being fed into the trimming apparatus by container infeed conveyor 51 to accommodate containers that have their necks in different horizontal and vertical positions and to accommodate containers of different heights and so that the scrap may be trimmed from the container along trim line 17 even though the height and position of the trim line may vary for different containers.

As perhaps best shown in FIGS. 1 and 2, both of the belts 23a, 23b may be vertically adjustably moved toward and away from container shelf 9 by means of a vertical screw jack 63. Specifically, both of the belts and their respective pulleys 27, 29, and drive motors 39a, 39b are mounted on a belt frame 65. This belt frame 65 is mounted on vertical slides 67 (as best shown in FIG. 5) and is connected to vertical screw jack 63 such that upon rotation of the screw jack, the belt frame and the belts 23a, 23b may be moved vertically as a unit relative to container support shelf 9 so as to adjust the height of the belts and the cutting blade 43 relative to the height of the container to be trimmed. This insures that the belts are in the proper heightwise position so as to grip the moil and so that the cutting blade 43 is in proper vertical alignment with the desired trim line 17.

Further, belts 23a, 23b may be moved as a unit in lateral direction so that the space between the inner reaches 25a, 25b of belts 23a, 23b is substantially centered with respect to the center of the neck or moil of the container to be trimmed. Still further, the inner reaches of the belts may be moved toward and away from one another so that the inner reaches of the belts properly grip the moil or the neck of the container so as to accommodate containers having necks 13 or scrap domes 15 of different widths or diameters. As shown in FIG. 1, the belt frame 24a carrying belt 23a is mounted for movement on belt frame 65 toward and away from belt 23b by means of a horizontal screw jack 69 which is journaled on bearing blocks 71a, 71b which in turn are mounted on plate 21. A nut 73 positioned between the bearing blocks is threadably engageable with a threaded shaft 75 of the screw jack 69. Nut 73 is mounted on a slide block 77 which is movable with the nut upon operation of screw jack 69 so as to effect horizontal movement of belt frame 24a and belt 23a toward and away from belt frame 24b and belt 23b. Thus, the horizontal space between the inner reaches 25a, 25b of the belts may be readily adjusted. Slide block 77 has a pair of clamps 79 received in transverse slots 81. In operation, when it is desired to adjust the spacing between the inner reaches 25a, 25b of belts 23a, 23b, the clamps 79 are loosened and screw jack 73 is operated so as to move nut and slide block 77 in transverse direction thereby to vary the spacing between the inner reaches of the belts. When the inner reaches of the belts are in their desired spaced relating, the clamps 79 are tightened thereby to lock the slide block 77 and the belts in desired spaced relation.

As indicated at 83, another horizontal screw jack is provided to move belt frames 24a, 24b and belts 23a, 23b in horizontal direction as a unit. As best shown in FIGS. 2 and 5, belt frame 24b is mounted on a slide 87 which is movable in horizontal direction toward and away from belt frame 24a and belt 23a by means of screw jack 83. In this way, the space between belts 23a, 23a may be adjusted relative to the centerline of the containers to be trimmed. Screw jack 83 is threadably connected to a nut 88 (see FIG. 2) which in turn is connected to slide 87. Thus, upon operation of the screw jack 83, slide 87 and belt frame 24b may be moved toward and away belt frame 24a and the inner reach of belt 23a. Thus, the centerline of the space between the belts may be adjusted in horizontal direction so as to both accommodate bottles having necks (scrap domes) of different diameters and so as to accommodate containers having offset necks. It will be appreciated that by horizontally adjusted so that the belts 23a, 23b will properly grip moil 15 and so that both of the belts may be centered with respect to the centerline of the container necks (or moils) as the containers are released from the infeed conveyor screw 53.

As indicated at 89, another vacuum inlet is provided downstream from the downstream end of blade 43. This vacuum inlet 89 draws air through the upper reach of belt 60 so as to grip the base of the containers after moils 15 have been trimmed and as the containers are released from the belts. This vacuum aids in stabilizing the containers on the belt 60 after the scrap has been trimmed. Of course, the vacuum source for vacuum inlet 89 may share the same vacuum source as vacuum inlet 54. As indicated at 91, conveyor belt 60 is driven by a variable speed VFD drive motor.

As indicated at 93 in FIG. 2, a diverter bar is provided so as to deflect the moils 15 trimmed from the containers to a scrap bin or the like (not shown). It will be appreciated that as the moils trimmed from the containers are released by belts 23a, 23b, the diverter bar will guide the released moils to the above-noted scrap bin.

Referring now to FIG. 7, the apparatus 1 is preferably (but not necessarily) provided with a computer controller C for controlling operation of spin trimmer 1 is shown in diagrammatic form. As indicated at 95, a human machine interface (e.g., a touch screen or a keyboard and a mouse, or the like) provides a signal to a programmable logic controller 97, which in turn, controls the above-described variable speed motors 39a, 39b, 57 and 91. It will be appreciated that controller C monitors the current supplied to motors 39a, 39b, 57 and 91. In the event that a container becomes jammed in the machine, the torque (and thus the current) required to turn the belts 23a, 23a and the infeed conveyor screw 51 will significantly increase. In the event the current supplied to these motors increases above a predetermined limit thus indicating that a container may have become jammed, the controller will automatically shut down trimmer 1 so as to prevent damage to belts 23a, 23b or other components of the trimmer. In particular, such torque sensing and trimmer shut down prevents the belts from slipping with respect to their respective drive pulleys 27 and thus prevents damage to the belts which in turn extends the service life of the belts. It will also be appreciated by those skilled in the art that photo-optic sensors may be placed at desired locations along the work path WP so as to optically sense jams of the containers if they occur. When a jam is sensed, signals are generated and the computer controller C will operate to shut down operation of the trimmer so that the jam may be cleared.

It will also be understood that controller C may be operated such that as the moil 15 is trimmed from the container 11 and such that as the trimmed container is released from belts 23a, 23b, the container may be positioned on the outfeed conveyor 60 so that the necks or handles of the containers are a predetermined oriented position. This will aid in packing of the containers in a secondary shipping container (e.g., a box) or will aid in the infeeding of the containers to a filling line (not shown).

As noted, the apparatus 1 preferably includes the computer control system C, as above described. However, those skilled in the art will recognize that the apparatus 1 may be operated and controlled without the use of such a computer control system. For example, the speed of the belts 23a, 23b may be controlled by using manually operated potentiometers to control the speed of motors 39a, 39b; 57; and 91.

As previously discussed, the tapered blade 45 is of sufficient length such that after the blade has initially cut through a portion of the moil 15 along trim line 17, the container will rotate at least through one full revolution so that the moil will be fully severed from the container neck. Moreover, by adjusting the taper of the blade (that is, the degree to which the blade angles inwardly), the location along the length of the blade (or along the work path WP) where the blade initially cuts through the wall of the moil along the trim line 17 may be adjusted so that the container is positioned at a desired rotational position (e.g., with the handle of a container oriented in a desired direction). This insures that when the moil is severed from the container so as to insure that containers are in a desired rotational position as they are deposited on the conveyor belt 60 to be conveyed from the trimmer. As noted, the vacuum opening 89 holds the trimmed containers in an erect position and in their desired rotational orientations as they are conveyed from the trimmer. It will be appreciated that the surface speed of the outfeed conveyor 60 is timed by controller C, see below, so that the trimmed containers are preferably speed synchronized at the container drop area (e.g., where the containers are released from belts 23a, 23b). This gives stability to the containers deposited on the outfeed conveyor and makes the trimmer 1 more robust and gives it a wider operating window so that it can trim containers of larger sizes and varied shapes.

More specifically, controller C is equipped with programmable logic controller or computer 97 and an operator input station 99, which are operably connected to the controller. Preferably (but not necessarily), the operator station includes a touch screen 99 so that various parameters of trimmer operation may be readily adjusted by the operator to accommodate containers of different sizes and moil diameters. Those skilled in the art will recognize that a computer keyboard and a mouse (not shown) may also be used as an operator input device in place of touchscreen 99. Further, controller C may be readily adjusted so that the number of containers trimmed/minute (or other time interval) may be readily varied. Specifically, an operator, by using the touch screen 99, can vary both the surface speeds of belts 23a, 23b and the speed differential between these belts. In this manner, the linear velocity at which containers are moved past blade 43 and the rotational speed of the moils as they are moved past the blade may be varied within a relatively wide range. In this manner, the number of revolutions of the moil as it is in cutting engagement with cutting blade surface 45 of blade 43 may be varied. The speed of rotation of infeed conveyor screw 53 and the surface speed of conveyor belt 60 may be scalably varied in conjunction with varying the speed of belts 23a, 23b. With controller C, when one variable (e.g., the number of containers trimmed/minute) is varied, the speed of the infeed conveyor 53, the belts 23a, 23b, and the speed of the conveyor belt 60 is scalably varied so as to accommodate the newly selected number of containers to be trimmed each minute. Heretofore, the adjustment up or down of the number of containers/minute required adjustment of the speeds of all of the drive motors independently of one another. This manual adjustment could take several minutes and would require several containers to be wasted while such adjustments were carried out.

In operation, containers 11 to be trimmed are delivered to apparatus 1 on shelf 9 or on conveyor 60 so as to engage infeed conveyor screw 53. As noted above, other infeed mechanisms may be used in place of screw 53, but the use of screw 53 is preferred. The containers will thus be received between the flights of the infeed conveyor. Rotation of conveyor screw 53 is controlled by variable speed motor 57 so as to regulate the rate at which containers 11 are fed into trim apparatus 1. Belts 23a, 23b are adjusted (as described above) so that the inner reaches 25a, 25b grip opposite sides of the moil (scrap) to be trimmed), as best shown in FIGS. 5 and 6. Belts 23a, 23b are driven by their respective variable speed drive motors 39a, 39b so that the inner reaches of both belts are driven in the same direction so as to move a container whose moil 15 gripped therebetween is conveyed along the work path WP from the infeed end of the conveyor to the outfeed end. The speed at which the belts are driven is such that the surface speed of one of the inner reaches is somewhat faster than the surface speed of the other inner reach. This speed differential causes the moil (and thus the container) to rotate about the central axis of the moil 15.

As best shown in FIG. 6, elongate knife blade 43 is positioned so as to cuttingly engage the neck of the container 11 along the trimline 17. Blade 43 is preferably an elongate blade that angles inwardly toward the centerline of the work path so as to fully cut through the wall of the moil as the container is conveyed along the work path and is caused to rotate by the speed differential of the inner reaches 25a, 25b of belts 23a, 23b gripping the moil. Preferably, the length of knife blade is greater than the circumference of the bottle necks or moils 15 to be trimmed. More preferably, the length of the knife blade is such that the blade is in cutting or trimming engagement with the container moil for than a full rotation of the neck and even more preferably for at least two rotations of the container neck. In some applications, it may be desirable to rotate the neck up to about 10 revolutions.

For example, if the outer diameter to the container neck to be trimmed is, say, 1.5 inches, the length of blade 43 is preferably somewhat longer than 2×1.5×π=9.42 inches. However, the blade 43 can be much longer. As noted, blade 43 is preferably heated so as to aid in smoothly trimming the moil from the neck of the container and for insuring a smooth trimline on the neck. It will be noted that after the moil 15 is trimmed from the neck of the container 11 that the moil remains captured between the inner reaches of the belts and thus the trimmed moil is positively conveyed from the trim apparatus. As the moil is ejected from between the belts, it may be readily fed into a moil collection bin (not shown). As shown in FIG. 6A, the blade 43 may be provided with a sharp corner 44 to make the initial penetration of the wall of the moil at a predetermined location along the blade. This helps insure that a sufficient length of the blade remains after the initial penetration so that the moil will rotate at least through one full revolution as it is conveyed past the blade by the belts 23a, 23b thereby to insure that the moil is fully severed from the container.

It will be understood by those skilled in the art that because the inner reaches 25a, 25b of belts 23a, 23b move in the same direction, but since the surface speed of one of the belts is only slightly different than the surface speed of the other belt, while the container gripped therebetween is caused to rotate, it rotates at a speed much more slowly than the rotational speed of prior art spin trimmers in which the belts move in opposite directions. This slower rotational speed of the container minimizes rotational speed of the container. With containers having offset necks, the rotation of the container results in an out of balance condition which results in wobbling of the container as it is conveyed through the trimming apparatus 1. Of course, the faster the rotational speed of the container, the greater its tendency to wobble and to come loose from the grip of the inner reaches of the belts. In this manner, the trimming apparatus of the present invention greatly diminishes the problem of certain prior art trimmers for containers being trimmed to become dislodged from between the conveying belts which typically requires the shutdown of the trimmed to remove such dislodged containers.

As noted, the inner reaches 25a, 25b of belts 23a, 23a move in the same direction, but the surface speed of one inner reach is somewhat greater or slower than the surface speed of the inner reach of the other belt. For example, if 10 containers/minute having a neck diameter of 1.5 inches are to be trimmed, and if the total length of the inner reaches of the belts is, for example 48 inches, the belts must be conveyed through the trimmer such that 10 containers/minute can be trimmed. This implies that the average surface speed of the inner reaches of the belts should be greater than 40 feet/minute, but in practice, somewhat faster surface speeds are used, for example 60 feet/minute. Since the inner reaches of the belts are driven at different speeds to cause the necks of the containers gripped between the inner reaches to rotate, in the instant example, the surface speed of the slowest belt should be greater than 40 feet/minute, and the surface speed of the inner reach of the other belt should be sufficiently faster so as to cause the neck to rotate more than one time as the container is conveyed along the length of the cutting edge 45 of knife blade 43.

It will be noted that the above-described apparatus 1 involves both a system for and a method of spin trimming a container 11 where the container is not spun at rotational speeds that cause large, unsymmetrical containers with offset necks to wobble so as to become disengaged from the belts moving the containers through the trimmer. Still further, the above-described trimmer operates reliably and at production speeds such that it may be installed in-line with production blow mold machines and which has a throughput capacity (i.e., the number of containers trimmed per minute or other unit time interval) sufficient to keep up with the production rates from such blow mold machines. The trimmer 1 results in the scrap being cleanly and reliably cut from the mouth of a blow molded container. Also, the trimmer 1 allows the spacing of the containers gripped by the belts so as to provide adequate spacing between adjacent containers such that containers with offset necks will not interfere with one another as they are rotated. The trimmer 1 allows the index spacing of containers on the infeed conveyor, the container transporting belts, and outfeed conveyors to be selectively varied, and the spacing is not fixed relative to the speed of the infeed conveyor.

Moreover, those skilled in the art will understand that the trimmer 1 in which the rotational speed of the container is not dependent upon the diameter of the portion of the container (e.g., the dome or moil) that is gripped by the belts and where the rotational speed of the containers may be selectively speeded up or slowed down while maintaining a desired linear speed of the containers transported through the trimmer. Further, the trimmer 1 substantially eliminates “chips” or “curls” as the scrap is trimmed from the container, and effectively disposes of the scrap trimmed from blow molded containers. Additionally, trimmer 1 can be operated over a relatively wide range of linear trimming speeds. The number of revolutions of the container as it is gripped by the belts of trimmer 1 may be varied, and the surface speeds of the infeed conveyor, the belts and the outfeed conveyor are scalable with respect to one another such that if the number of containers to be trimmed in a given time interval (e.g., the number of containers/minute) is changed, the corresponding speeds of the infeed conveyor, the container gripping belts, and the outfeed conveyor are automatically synchronized. Of course, the trimmer 1 is reliable in operation, which is economical to manufacture, and which has a long service life.

As various changes could be made in the above constructions without departing from the scope of the invention, it is intended that all matter contained in the above description or shown in the accompanying drawings shall be interpreted as illustrative and not in a limiting sense.

1. Apparatus for trimming scrap material, such as a dome or moil, from a plastic object, said object having said scrap material attached to said object, said apparatus comprising:
a pair of power driven endless belts, each of said belts having an inner reach with the inner reaches of the belts being spaced apart from one another so as to grip a portion of said object therebetween and so as to move said object along a path;
said belts being driven so that said inner reaches of each of the belts move in the same direction so that a object is conveyed along said path, one of said belts being driven at a surface speed faster than the surface speed of the other belt so as to rotate said object; and
an elongate blade extending along at least a portion of said path and positioned proximate to one said path so as to trim said scrap from said object as said object is conveyed along said path and as said object is rotated by said belt reaches.

2. Apparatus as set forth in claim 1 wherein said one of said belts is driven at a surface speed faster than the surface speed of said second belt such that said object gripped between said belt reaches and conveyed along said path will rotate between about one revolution and about ten revolutions as said object is conveyed along said path such that even if said neck of said object is offset relative to said object, said object being rotated at a sufficiently slow rotational speed so as to substantially prevent wobbling of said object with sufficient force so as to dislodge the object from the grip of said inner belt reaches while said object is conveyed along said path.

3. Apparatus as set forth in claim 1 further comprising an object infeed conveyor operable to feed objects to be trimmed at a desired rate and with a desired spacing between adjacent objects so as to prevent interference between the objects as they are gripped by the inner reaches of the belts and as the objects are rotated.

4. Apparatus as set forth in claim 1 wherein said belts and said elongate blade are carried by a frame, said frame being adjustable in heightwise direction so that said reaches of said belts grip said object at a desired location.

5. Apparatus as set forth in claim 4 wherein said elongate blade is carried by said frame, said blade being adjustably mounted with respect to said frame such that with said belts gripping said object at said desired location, said blade is positioned so as to trim said scrap from said object as said object is conveyed along said path.

6. Apparatus as set forth in claim 5 where in said elongate blade angles inwardly toward said objects moved along said path such that said blade progressively cuts said scrap from an object as said object is moved along said path.

7. Apparatus as set forth in claim 1 wherein said object is a container having a neck where said scrap is attached to said neck, and wherein the inner reaches of said belts grip the scrap to be trimmed from the neck of the container.

8. Apparatus as set forth in claim 7 wherein said knife blade cuttingly engages a trim line between said scrap and the upper end of the container neck.

9. Apparatus as set forth in claim 1 wherein said blade has a penetrator that initially forms the initial penetration of the wall of said objects at a predetermined location along the length of the blade.

10. Apparatus as set forth in claim 1 having a conveyor belt for aiding the infeed of objects to be trimmed, said conveyor belt having a vacuum inlet in communication with the upper reach of said conveyor belt so as to aid in holding objects on said conveyor belt as they are conveyed to said belts that grip a portion of said objects.

11. Apparatus as set forth in claim 1 further comprising an object infeed conveyor receiving objects to be trimmed and outputting objects to be trimmed at a predetermined rate.

12. Apparatus as set forth in claim 11 further comprising a computer control system for controlling the speed of said belts gripping said objects and for controlling said object infeed conveyor, wherein, upon changing the throughput rate of said apparatus, the speeds of said belts and of said infeed conveyor are scalably varied.

13. A method of trimming scrap material from a plastic object or container, the latter having a neck and said scrap material being attached to said neck, said method comprising the steps of:
gripping a portion of said container to be trimmed between a pair of spaced belt reaches;
driving both of said belt reaches in the same direction so as to convey said container along a path;
driving one of said belt reaches at a surface speed faster than the surface speed of the other belt reach so as to rotate the neck of said container about a vertical axis; and
positioning an elongate knife blade along said path so as to trim said scrap from said neck as said container is conveyed and rotated along said path.

14. The method of claim 13 wherein the step of gripping a portion of said container involves gripping the scrap to be trimmed from said neck of said container.

15. The method of claim 13 wherein said one belt is driven at a surface speed faster than the surface speed of said second belt such that said container is rotated between about one revolution and about 10 revolutions as said container is conveyed along said path.

16. The method of claim 13 wherein, after said blade has initially penetrated through the portion of said container to be trimmed, said container is rotated through at least one full revolution by said belts so as to sever the scrap from said container.

17. The method of claim 13 further comprising heating said knife blade to as to aid in trimming said scrap from the neck of said container.

18. The method of claim 13 further comprising adjustably mounting said belts so as accommodate containers of different heights.

19. The method of claim 13 further comprising mounting said belts so as to be adjustably movable toward and away from one another so as grip containers of different sizes.

20. The method of claim 19 further comprising adjustably mounting said belts so as to be movable toward and away from one another so as to be centered with respect to the axis of said container neck.

21. The method of claim 19 comprising adjustably mounting said belts so as to be adjustable in heightwise direction so as to trim said scrap from containers of different heights.
